(19) United States
(12) Patent Application Publication
(10) Pub. No.: US 2010/0141777 A1
(43) Pub. Date: Jun. 10, 2010

(54) DISPLAY APPARATUS AND METHOD OF DISPLAYING POWER COMSUMPTION THEREOF

(75) Inventors: Kyoung-mi Jin, Seongnam-si (KR); Jin-young Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/498,810

(22) Filed: Jul. 7, 2009

(30) Foreign Application Priority Data
Dec. 5, 2008 (KR) 10-2008-0123406

(51) Int. Cl. H04N 17/02

(52) U.S. Cl. 348/189; 348/E17.004

(57) ABSTRACT

A display apparatus which displays its power consumption and a method of displaying power consumption thereof, are provided. The method of displaying power consumption of a display apparatus which includes a display, the method including: measuring power consumption of the display apparatus; displaying power consumption information about a measured power consumption and a settings menu to adjust a setting value involved in controlling the display apparatus on the display; and displaying power consumption information which is changed in accordance with an adjusted setting value on the display. The display apparatus and the method provide displaying power consumption on a screen, the power consumption being changed by adjusting setting values involved in controlling the display apparatus.

### CROSS-REFERENCE TO RELATED APPLICATION

This application claims priority from Korean Patent Application No. 10-2008-0123406, filed on Dec. 5, 2008 in the Korean Intellectual Property Office, the disclosure of which is incorporated herein in it's entirety by reference.

### BACKGROUND OF THE INVENTION

1. Field of the Invention

Apparatuses and methods consistent with the present invention relate to a display apparatus, and more particularly to a display apparatus which displays its power consumption and a method of displaying power consumption thereof.

2. Description of the Related Art

Large-sized display apparatuses, e.g., large-sized televisions (TVs), have been widely employed in recent years. The large-sized TVs consume more electric power than small-sized TVs and require even more electric power to display images of superior quality.

Users are not aware of how much power TVs consume and how to decrease power consumption in of TVs when they are in use.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

According to an aspect of the present invention, there is provided a display apparatus which displays its power consumption on a screen and a method of displaying power consumption thereof.

According to another aspect of the present invention, there is provided a display apparatus which displays its power consumption on a screen, the power consumption being changed by adjusting setting values involved in controlling the display apparatus, and a method of displaying power consumption thereof.

The foregoing and/or other aspects of the present invention may be achieved by providing a method of displaying power consumption of a display apparatus which comprises a display, the method including: measuring power consumption of the display apparatus; displaying power consumption information about a measured power consumption and a settings menu to adjust a setting value involved in controlling the display apparatus on the display; and displaying power consumption information which is changed in accordance with an adjusted setting value on the display.

The method may further include generating power consumption information using the measured power consumption.

The generating of the power consumption information may include generating information to display current power consumption of the display apparatus using the measured power consumption.

The generating of the power consumption information may further include generating information to display average power consumption per day of the display apparatus using the measured power consumption.

The generating of the power consumption information may further include generating information to display power consumption based on the time zone of the display apparatus using the measured power consumption.

The generating of the power consumption information may further include generating information to display a power rate of the display apparatus using the measured power consumption.

The setting value may include at least one of a screen setting value, a backlight unit setting value, and an audio setting value.

According to another aspect of the present invention, there is provided a display apparatus including: a power measurement unit which measures power consumption; a display; a user interface generator which generate user interface information; and a controller which displays power consumption information about a measured power consumption and a settings menu to adjust a setting value involved in control of the display, and controls the user interface generator to display power consumption information which is changed in accordance with an adjusted setting value on the display.

The controller may calculate power consumption information using the measured power consumption.

The power consumption information may include current power consumption.

The power consumption information may include average power consumption per day.

The power consumption information may include power consumption based on the time zone.

The power consumption information may include a power rate.

The setting value may include at least one of a screen setting value, a backlight unit setting value, and an audio setting value.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram illustrating a configuration of a display apparatus according to an exemplary embodiment of the present invention;

FIG. 2 illustrates a screen of the display apparatus according to an exemplary embodiment of the present invention;

FIG. 3 is a flow chart to illustrate a method of displaying power consumption of the display apparatus according to an exemplary embodiment of the present invention; and

FIG. 4 is a block diagram illustrating a configuration of a display apparatus according to another exemplary embodiment of the present invention.

### DETAILED DESCRIPTION OF EXEMPLARY EMBODIMENTS OF THE INVENTION

Below, exemplary embodiments of the present invention will be described in detail with reference to accompanying drawings so as to be easily realized by a person having ordinary knowledge in the art. The present invention may be embodied in various forms without being limited to the embodiments set forth herein. Descriptions of well-known parts are omitted for clarity, and like reference numerals refer to like elements throughout.

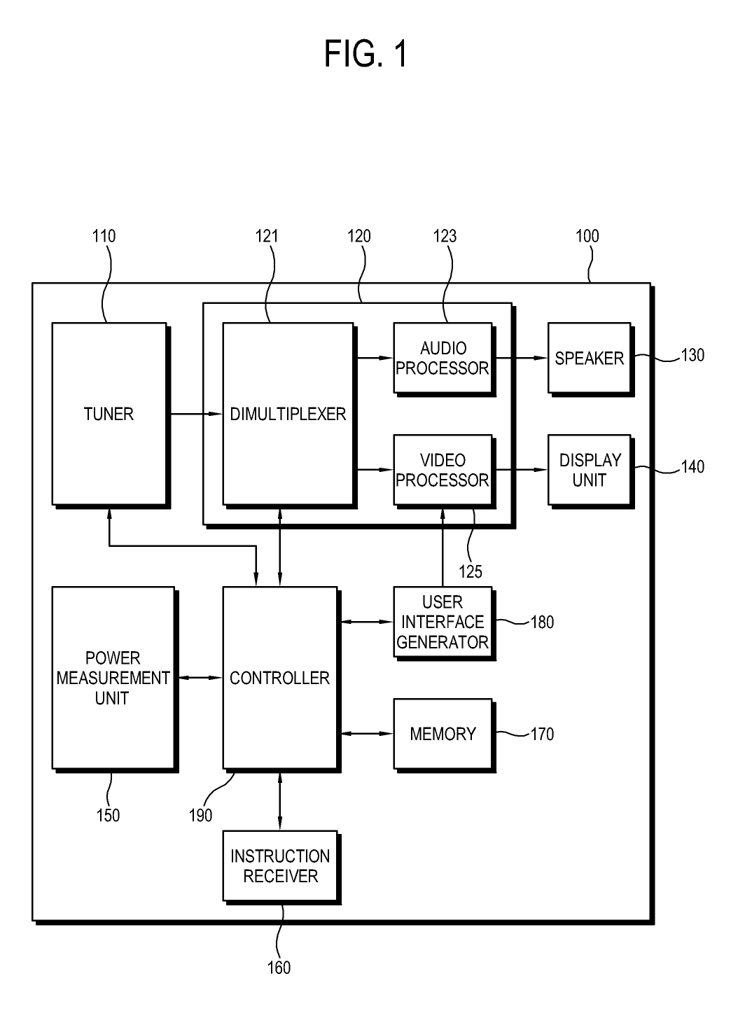

FIG. 1 is a block diagram schematically illustrating a configuration of a display apparatus according to an exemplary embodiment of the present invention.

Referring to FIG. 1, a display apparatus 100 includes a tuner 110, a signal processor 120, a speaker 130, a display unit 140, a power measurement unit 150 (which may be implemented as hardware, for example), an instruction receiver 160, a memory 170, a user interface (UI) generator 180, and a controller 190.

The tuner 110 tunes a broadcasting signal having a frequency band corresponding to a channel selected by the controller 190, which is discussed later, and demodulates and rectifies it to be output, e.g., into a transport stream (TS) packet.

The signal processor 120 includes a dimultiplexer 121, an audio processor 123, and a video processor 125.

The dimultiplexer 121 divides out broadcasting signals modulated by the tuner 110 into various data such as video data, audio data, and Program and System Information Protocol (PSIP) to be output in the bit stream.

The audio processor 123 decodes audio data divided by the dimultiplexer 121 and processes them in accordance with output specifications of the speaker 130 to be output.

The video processor 125 decodes video data divided by the dimultiplexer 121 and processes them to have a vertical frequency, a screen resolution, an aspect ratio, etc. in accordance with output specifications of the display unit 140. Further, the video processor 125 scales UI information generated by the UI generator 180, discussed later, and video data so that the UI information is displayed on the display unit 140 along with the video data.

The speaker 130 amplifies an audio data output from the audio processor 123 to a predetermined-magnitude sound.

The display unit 140 outputs a video data from the video processor 125 and a user interface as images.

The power measurement unit 150 measures power consumption of the display apparatus 100.

The instruction receiver 160 includes a variety of keys through which a user's instructions are input and may include an infrared receiver which receives a user's instructions transmitted from a remote control (not shown). The instruction receiver 160 may also include a receiver which receives user's instructions transmitted from a remote control (not shown) such as a pointing device. The remote control transmits signals in an infrared or radio frequency (RF) format, and the instruction receiver 160 receives the corresponding signals. Meanwhile, the instruction receiver 160 may be combined with the display unit 140 to be realized in a touch panel. A user's instruction input through the instruction receiver 160 is converted into a corresponding key signal to be transmitted to the controller 190. A user can input a signal to generate UI information and a signal to carry out a specific control with reference to the UI information through the instruction receiver 160.

The memory 170 stores a variety of programs and data required to perform operations of the display apparatus 100. The memory 170 may also store power consumption information measured by the power measurement unit 150.

The UI generator 180 generates an on-screen display (OSD) menu for users to set up functions of the display apparatus 100 and various UI information about power consumption according to control of the controller 190. The UI information generated by the UI generator 180 includes information about power consumption measured and a settings menu to adjust a predetermined setting value of the display apparatus 100.

The controller 190 controls the above components to conduct proper functions according to a user's instructions input through the instruction receiver 160. For example, the controller 190 receives power consumption information measured by the power measurement unit 150, deduces various other informations related to power consumption using the received power consumption information and controls the UI generator 180 to display the information deduced from the measured power consumption on the display unit 140.

The controller 190 calculates a current power consumption of the display apparatus 100 using the measured power consumption. The controller 190 also calculates average power consumption per day of the display apparatus 100 using the measured power consumption. Further, the controller 190 calculates power consumption based on the time zone of the display apparatus 100 using the measured power consumption. Meanwhile, the controller 190 calculates a power rate of the display apparatus 100 using the measured power consumption. In short, the controller 190 calculates information about power consumption such as current power consumption, average power consumption per day, power consumption based on the time zone, a power rate, etc. and controls the UI generator 180 to generate UI information about the power consumption information.

Setting values involved in controlling the display apparatus 100 may be at least one of a screen setting value, a backlight unit setting value and an audio setting value.

The memory 170 stores at least one of information to display current power consumption, information to display average power consumption per day, information to display power consumption based on the time zone, and information to display a power rate, which are calculated by the controller 190.

Hereinafter, an illustrative example of a user interface generated by the UI generator 180 will be illustrated.

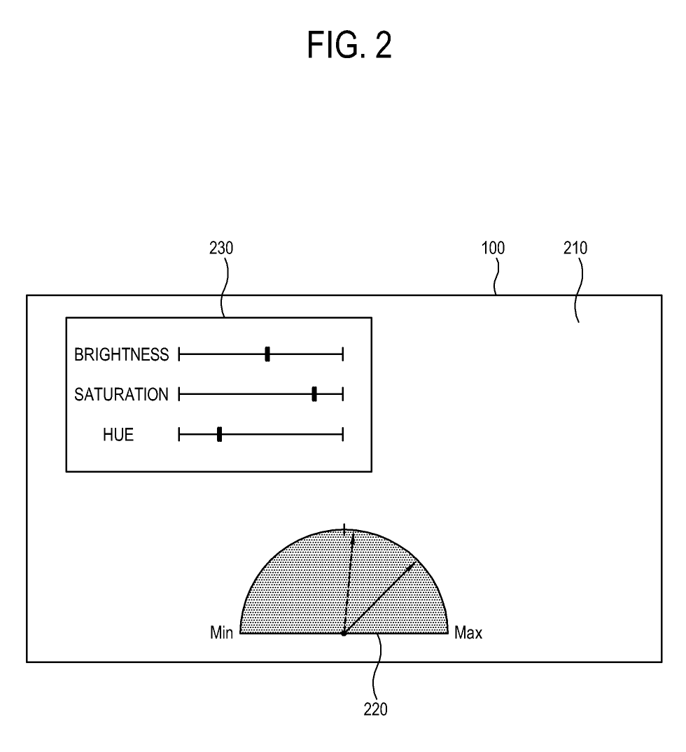

FIG. 2 illustrates a user interface displayed on the display apparatus 100 according to an exemplary embodiment of the present invention. Referring to FIG. 2, the screen 210 displays a broadcasting program, and further displays another image, e.g., power consumption information 220 and a menu 230. The screen 210 refers to a portion of the display unit 140 where images are displayed.

The power consumption information 220 of FIG. 2 is, for example, information about current power consumption of a display apparatus 100. Further, the power consumption information 220 may be one of information about average power consumption per day of the display apparatus 100, information about power consumption based on the time zone, and information about a power rate.

The controller 190 receives a signal from a user via the instruction receiver 160 to select information to be displayed on the screen 200 among the power consumption information 220. If the user selects current power consumption, the controller 190 controls the UI generator 180 to display current power consumption information of the display apparatus 100 using the power consumption information measured by the power measurement unit 150. If the user wants to know average power consumption per day, the controller 190 calculates average power consumption per day using power consumption information measured by the power measurement unit 150 and stored in the memory 170 and controls the UI generator 180 to display the average power consumption per day. If the user wants to know power consumption based on the time zone or a power rate, the controller 190 controls the UI generator 180 to display power consumption based on the time zone or a power rate, calculated by the power measurement unit 150 and the memory 170.

The settings menu 230 shown in FIG. 2 displays UI information to adjust setting values of the display apparatus 100. The settings menu 230 may include items to adjust screen settings, as shown in the FIG. 2. The screen settings include brightness, contrast, saturation, hue, etc. The items of the settings menu 230 are adjustable by a user, and the controller 190 changes power consumption information 220 in accordance with an adjusted item. For example, the power consumption information 220 illustrates power consumption in real time expressed by a solid line and, if a user adjusts an item of the settings menu, power consumption corresponding to the adjusted item is expressed by a dotted line. The user can adjust an item displayed on the settings menu 230, and accordingly determine a change in the power consumption information 220.

Additionally, the settings menu 230 may include an item to change setting values of a backlight unit (BLU). Here, when a setting value of the backlight unit is adjusted, a detail displayed on the power consumption information 220 is changed.

Meanwhile, the settings menu 230 may include items to adjust the sound setting. The sound setting may include a high-range sound value, a low-range sound value, a sound balance value, etc. For example, if an item about low-range sound displayed on the settings menu 230 is adjusted, a detail displayed on the power consumption information 220 is changed.

In conclusion, while displaying power consumption information, e.g., the power consumption information 220, on the screen 210, the controller 190 displays a window to adjust a setting value involved in control of the display apparatus 100, e.g., the settings menu 230, and also displays power consumption changed in accordance with the adjusted setting value on the screen 210.

As described above, setting values related to controlling the display apparatus 100 have been explained with the screen setting values, the backlight unit setting values, and the sound setting values, but are not limited thereto. For example, power consumption may be changed by an input source of an image signal displayed on the screen 210, e.g., TV broadcasting signals, DVD contents, PC images, etc., and accordingly the setting values of the display apparatus 100 may be changed by selection of input.

Further, in the foregoing exemplary embodiments, power consumption information has been illustrated with current power consumption, average power consumption per day, power consumption based on the time zone, and a power rate, but is not limited thereto.

Meanwhile, the power consumption information 220 is expressed as a picture in FIG. 2, but is not limited thereto. For example, the power consumption information 220 may be expressed by numbers or letters.

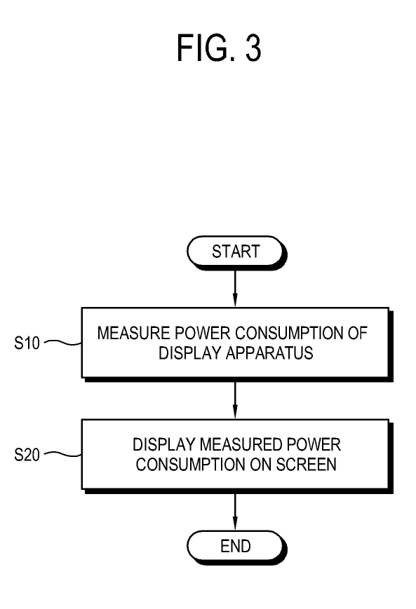

FIG. 3 is a flow chart to illustrate a method of displaying power consumption of the display apparatus according to an exemplary embodiment of the present invention.

As illustrated in FIG. 3, the method of displaying power consumption of the display apparatus 100 according to an exemplary embodiment of the present invention includes measuring power consumption of the display apparatus 100 (S10), and displaying the power consumption on the screen (S20). While the power consumption is displayed on the screen, a window to adjust setting values of the display apparatus 100 may also be displayed, and then the change in power consumption in accordance with an adjusted value is displayed on the screen.

The method of displaying power consumption may further include generating information recognizable by a user using the measured power consumption. Also, the operation S20 may further include displaying the generate information about the measured power consumption.

The generating information may include generating information to display current power consumption of the display apparatus 100 using the measured power consumption. The generating information may also include generating information to display average power consumption of the display apparatus 100 using the measured power consumption. The generating information may further include generating information to display power consumption based on the time zone of the display apparatus 100 using the measured power consumption. Additionally, the generating information may further include generating information to display a power rate of the display apparatus 100 using the measured power consumption.

The setting values of the display apparatus 100 may be at least one of screen setting values, backlight unit setting values, and audio setting values.

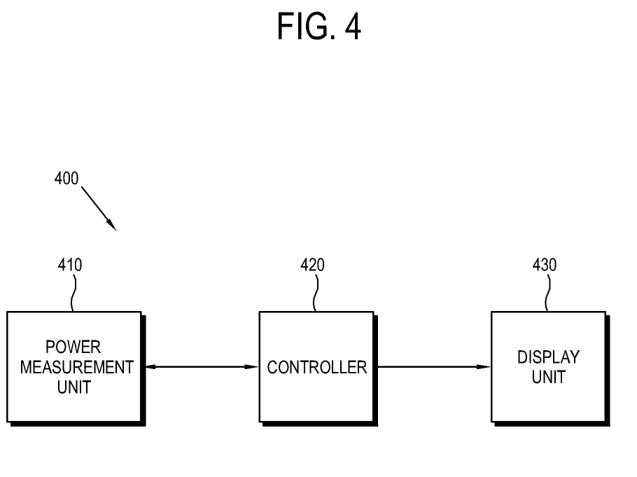

FIG. 4 illustrates a display apparatus 400 according to another exemplary embodiment of the present invention.

Referring to FIG. 4, the display apparatus 400 includes a power measurement unit 410, a controller 420, and a display unit 430.

The power measurement unit 410 measures power consumption of the display apparatus 400. The display unit 430 displays the measured power consumption on a screen.

The controller 420 displays a window to adjust setting values of the display apparatus 400 on the screen while displaying the power consumption and controls the display unit 430 to display power consumption which is changed in accordance with an adjusted setting value on the screen.

The controller 420 converts the measured power consumption into information recognizable by a user and controls the display unit 430 to display the information of the power consumption on the screen.

Meanwhile, the controller 420 generates information to display current power consumption of the display apparatus 400 using the measured power consumption. The controller 420 also generates information to display average power consumption per day of the display apparatus 400 using the measured power consumption. The controller 420 further generates information to display power consumption based on the time zone of the display apparatus 400 using the measured power consumption. Additionally, the controller 420 generates information to display a power rate of the display apparatus 400 using the measured power consumption.

The setting values of the display apparatus 100 may be at least one of screen setting values, backlight unit setting values, and audio setting values.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of displaying power consumption of a display apparatus which comprises a display, the method comprising:
measuring power consumption of the display apparatus;
displaying, on the display, power consumption information about a measured power consumption and a settings menu to adjust a setting value involved in controlling the display apparatus; and
displaying power consumption information changed in accordance with an adjusted setting value on the display.

2. The method according to claim 1, further comprising generating power consumption information using the measured power consumption.

3. The method according to claim 2, wherein the generating the power consumption information generates information to display current power consumption of the display apparatus using the measured power consumption.

4. The method according to claim 2, wherein the generating the power consumption information generates information to display average power consumption per day of the display apparatus using the measured power consumption.

5. The method according to claim 2, wherein the generating the power consumption information generates information to display power consumption based on a time zone of the display apparatus using the measured power consumption.

6. The method according to claim 2, wherein the generating the power consumption information generates information to display a power rate of the display apparatus using the measured power consumption.

7. The method according to claim 1, wherein the setting value comprises at least one of a screen setting value, a backlight unit setting value, and an audio setting value.

8. A display apparatus comprising:
a power measurement unit which measures power consumption;
a display;
a user interface generator which generates user interface information; and
a controller which displays power consumption information about a measured power consumption and a settings menu to adjust a setting value involved in control of the display, and controls the user interface generator to display power consumption information which is changed in accordance with an adjusted setting value on the display.

9. The display apparatus according to claim 8, wherein the controller calculates power consumption information using the measured power consumption.

10. The display apparatus according to claim 9, wherein the power consumption information comprises current power consumption.

11. The display apparatus according to claim 9, wherein the power consumption information comprises average power consumption per day.

12. The display apparatus according to claim 9, wherein the power consumption information comprises power consumption based on a time zone.

13. The display apparatus according to claim 9, wherein the power consumption information comprises a power rate.

14. The display apparatus according to claim 8, wherein the setting value comprises at least one of a screen setting value, a backlight unit setting value, and an audio setting value.
